(19) United States
(12) Patent Application Publication
(10) Pub. No.: US 2025/0091595 A1
(43) Pub. Date: Mar. 20, 2025

(54) VEHICLE AND METHOD OF CONTROLLING POWER SUPPLY OF VEHICLE IN EMERGENCY SITUATION

(71) Applicants: Hyundai Motor Company, Seoul (KR); Kia Corporation, Seoul (KR)

(72) Inventor: Sang Wook Park, Seoul (KR)

(21) Appl. No.: 18/890,931

(22) Filed: Sep. 20, 2024

(30) Foreign Application Priority Data
Sep. 20, 2023 (KR) 10-2023-0125634

(51) Int. Cl. B60W 50/08; B60R 16/033; B60W 30/188

(52) U.S. Cl. CPC B60W 50/082; B60R 16/033; B60W 30/1886

(57) ABSTRACT

A vehicle and a method of controlling the vehicle are configured to operate only essential loads of the vehicle in an emergency driving situation. The vehicle includes at least one essential electronic device belonging to a first load class, at least one general electronic device belonging to a second load class, a power supply system configured to supply power to the at least one essential electronic device and the at least one general electronic device, a switch configured to switch an electrical connection between the power supply system and the at least one general electronic device, and a controller configured to control the switch, where the controller is configured to control the switch to turn on or off the power supply to the at least one general electronic device based on a power state of the power supply system and a predicted driving distance to a destination.

### CROSS-REFERENCE TO RELATED APPLICATION

This application claims under 35 U.S.C. § 119 (a) the benefit of Korean Patent Application No. 10-2023-0125634, filed on Sep. 20, 2023, the entire contents of which are incorporated by reference herein.

### BACKGROUND

### (a) Technical Field

The present disclosure relates to a vehicle and a vehicle control method, more particularly, to the vehicle in which a power supply of the vehicle may be switched to only essential loads in an emergency driving situation.

### (b) Description of the Related Art

In case of an emergency such as a system malfunction in a vehicle while the vehicle is driving, one of the known technologies that restrict functions of the vehicle according to a preset control mechanism may be used.

For example, when an abnormality occurs in a power supply system such as a battery during autonomous driving, a known technology that cuts off the power supply to some of power loads in a vehicle and moves the vehicle to a safe place to stop the vehicle there may be used.

Although there are such technologies for responding to emergencies, they typically have limitations in terms of user convenience and may fail to provide various driving modes in case of emergencies.

### SUMMARY

An object of the present disclosure is to provide a control method and a vehicle that may increase an available driving distance by selecting an appropriate driving mode when a predicted driving distance to a destination is not satisfied.

To solve the preceding technical problems, according to at least one embodiment of the present disclosure, there is provided a vehicle including at least one essential electronic device belonging to a first load class, at least one general electronic device belonging to a second load class, a power supply system configured to supply power to the at least one essential electronic device and the at least one general electronic device, a switch configured to switch an electrical connection between the power supply system and the at least one general electronic device, and a controller configured to control the switch, wherein the controller may be configured to control the switch to turn on or off a power supply to the at least one general electronic device based on a power state of the power supply system and a predicted driving distance to a destination.

According to at least one embodiment, the first load class may include essential loads for devices necessarily operated to drive the vehicle, and the second load class may include convenience loads for devices optionally operated for a user convenience.

According to at least one embodiment, the essential loads may include a load related to at least one of a motor driven power steering (MDPS) system, an integrated electric brake (IEB), a vehicle control unit (VCU), an electric power control unit (EPCU), an electric oil pump (EOP), an advanced driver assistance system (ADAS), headlamps, turn signals, a brake light, wipers, an instrument panel (cluster), a door unlock system, and a body domain controller (BDC). According to at least one embodiment, the power state may include an available driving distance of a battery of the vehicle.

According to at least one embodiment, the controller may be configured to: in response to the available driving distance being less than the predicted driving distance, display an available driving distance for each of at least one driving mode through a screen in the vehicle.

According to at least one embodiment, the at least one driving mode may include at least one of a driver driving mode, an autonomous driving mode, and a super fuel-efficient driving mode.

According to at least one embodiment, the controller may be configured to: based on a selection by a driver of the vehicle or a comparison of the available driving distance for each driving mode, determine one from among the driver driving mode, the autonomous driving mode, and the super fuel-efficient driving mode.

According to at least one embodiment, in the super fuel-efficient driving mode, the power supply to the at least one general electronic device may be turned off.

According to at least one embodiment, in the super fuel-efficient driving mode, sudden acceleration and/or sudden start may be restricted, and emergency lights may blink.

According to at least one embodiment, the controller may be configured to store a fuel efficiency in the driver driving mode and/or the autonomous driving mode.

To solve the preceding technical problems, according to at least one embodiment of the present disclosure, there is provided a method of controlling a vehicle including at least one essential electronic device belonging to a first load class, at least one general electronic device belonging to a second load class, a power supply system configured to supply power to the at least one essential electronic device and the at least one general electronic device, a switch configured to switch an electrical connection between the power supply system and the at least one general electronic device, and a controller configured to control the switch, the method including by the controller, controlling the switch to turn on or off a power supply to the at least one general electronic device based on a power state of the power supply system and a predicted driving distance to a destination.

According to at least one embodiment, the first load class may include essential loads for devices necessarily operated to drive the vehicle, and the second load class may include convenience loads for devices optionally operated for a user convenience.

According to at least one embodiment, the essential loads may include a load related to at least one of an MDPS system, an IEB, a VCU, an EPCU, an EOP, an ADAS, headlamps, turn signals, a brake light, wipers, an instrument panel (cluster), a door unlock system, and a BDC.

According to at least one embodiment, the power state may include an available driving distance of a battery of the vehicle.

According to at least one embodiment, the method may include, in response to the available driving distance being less than the predicted driving distance, displaying, by the controller, an available driving distance for each of at least one driving mode through a screen in the vehicle.

According to at least one embodiment, the at least one driving mode may include at least one of a driver driving mode, an autonomous driving mode, and a super fuel-efficient driving mode.

According to at least one embodiment, the method may include determining, by the controller, one from among the driver driving mode, the autonomous driving mode, and the super fuel-efficient driving mode, based on a selection by a driver of the vehicle or a comparison of the available driving distance for each driving mode.

According to at least one embodiment, in the super fuel-efficient driving mode, the power supply to the at least one general electronic device may be turned off.

According to at least one embodiment, in the super fuel-efficient driving mode, sudden acceleration and/or sudden start may be restricted, and emergency lights may blink.

According to at least one embodiment, the method may include storing, by the controller, a fuel efficiency in the driver driving mode and/or the autonomous driving mode.

According to embodiments of the present disclosure described herein, when there is no way to satisfy a predicted driving distance to a destination, selecting an appropriate driving mode may increase an available driving distance.

Specifically, embodiments of the present disclosure described herein, providing a fuel efficiency for each driving mode may allow a driver to select an optimal driving mode that may satisfy the predicted driving distance to the destination.

According to embodiments of the present disclosure described herein, the available driving distance may be maximized through a super fuel-efficient driving mode that supplies power only to essential loads required for driving.

### BRIEF DESCRIPTION OF THE DRAWINGS

FIG. 1 illustrates a topology of a power supply system according to an embodiment of the present disclosure.

FIG. 2 illustrates a control process according to an embodiment of the present disclosure.

FIG. 3 illustrates examples of power loads in a vehicle.

### DETAILED DESCRIPTION OF THE DISCLOSURE

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, embodiments of the present disclosure will be described in detail with reference to the accompanying drawings. The embodiments are not construed as limited to the disclosure and should be understood to include all changes, equivalents, and replacements within the idea and the technical scope of the disclosure.

Although terms including ordinal numbers, such as “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit” or “control unit” is merely a widely used term for naming a controller that controls a specific vehicle function, and does not mean a generic functional unit. For example, each controller may include a communication device that communicates with another controller or a sensor to control a function assigned thereto, a memory that stores an operating system (OS), a logic command, input/output information, and the like, and one or more processors that perform determination, calculation, decision, and the like that are necessary for controlling a function assigned thereto.

Meanwhile, a processor may include a semiconductor integrated circuit and/or electronic devices that perform at least one or more of comparison, determination, computation, operations, and decision to achieve programmed functions. The processor may be, for example, any one or a combination of a computer, a microprocessor, a central processing unit (CPU), an application-specific integrated circuit (ASIC), and an electronic circuit (e.g., circuitry and logic circuits).

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, embodiments of the present disclosure will be described in detail with reference to the accompanying drawings.

First, according to embodiments, a power supply system may include, but is not necessarily limited to, a high-voltage battery (HV), a low-voltage direct current to direct current (DC/DC) converter (LDC), and a low-voltage battery (12V BATT).

According to embodiments, a vehicle may include essential electronic devices belonging to a first load class and general electronic devices belonging to a second load class.

The first load class may correspond to an essential load, and the second load class may correspond to another load, for example, a load related to user convenience (or a convenience load).

In an embodiment, the essential electronic devices may include a motor driven power steering (MDPS) system, an integrated electric brake (IEB), a vehicle control unit (VCU), an electric power control unit (EPCU), an electric oil pump (EOP), an advanced driver assistance system (ADAS), headlamps, turn signals, a brake light, wipers, a display device including an instrument panel (cluster) and/or a navigation system, a door unlock system, a body domain controller (BDC), and the like.

The MDPS system may refer to a power steering system that connects a motor to a steering shaft connected to the front wheels of a vehicle such that a steering wheel of the vehicle may be turned with a less force.

The IEB may refer to an integrated electric brake.

In addition, the VCU may be used for drive motor control, regenerative braking control, air conditioning load control, electric load power supply control, cluster display, distance to empty (DTE), reserved/remote charging/air conditioning, analog/digital signal processing, diagnosis, and the like.

The EPCU may be a device that controls the overall movement of a vehicle by, for example, controlling a drive motor in an electric vehicle, and may perform similar functions to those performed by an electronic control unit (ECU) and a transmission control unit (TCU) of an existing vehicle with an internal combustion engine.

The EOP may be a device responsible for cooling and lubrication of a reducer.

The ADAS, which is an intelligent driver assistance system, may include, for example, smart cruise control (SCC), forward collision warning (FCW), forward collision-avoidance assist (FCA), blind-spot collision warning (BCW), lane departure warning (LDW), lane keeping assist (LKA), high beam assist (HBA), low beam assist (LBA), highway driving assist (HDA), and the like.

The BDC may refer to a platform controller that provides electronic functions to a body domain area, and may perform at least one of functions including a body control function, a smart key entry/start function, a tire pressure monitoring function, an immobilizer function, a digital key authentication function, and an autonomous parking-related control function, and the like.

The general electronic devices may be electronic devices provided for driver convenience functions, excluding the essential electronic devices described above. The general electronic devices may include, for example, an air conditioning device, an infotainment device, an electric seat adjustment device, and the like.

In an embodiment, the vehicle may also include a junction block including a first switch SW1 that connects a power supply of the low-voltage DC/DC converter LDC and the low-voltage battery 12V BATT to the MDPS, the IEB, the VCU, the EPCU, the EOP, the ADAS, the headlamps, the turn signals, the brake light, the wipers, and the like among the essential electronic devices, and that switches the power supply to a first general electronic device GL1 and a second general electronic device GL2.

In addition, the vehicle may also include a power control unit (PDC) including a second switch SW2 that connects power supply to the cluster, the door unlock system, the BDC, and the like among the essential electronic devices, and that switches the power supply to a third general electronic device GL3, a fourth general electronic device GL4, a fifth general electronic device GL5, and the like.

The first switch SW1 and the second switch SW2 may operate under the control of a controller CU, and the controller CU may control the display device (e.g., the cluster or the navigation system, etc.) in the vehicle.

Under the control of the controller CU for the first switch SW1 and the second switch SW2, the power supply to the general electronic devices including the first to fifth general electronic devices GL1 to GL5 may be turned on or off.

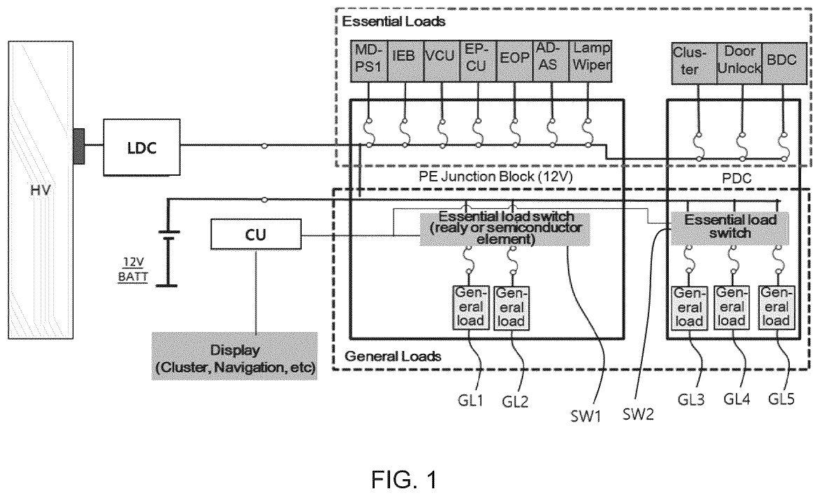

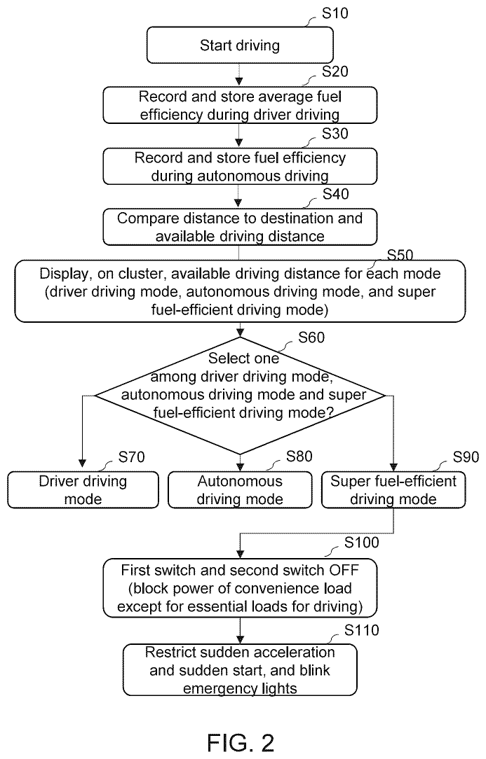

FIG. 2 illustrates a control process performed on an electric vehicle including the power supply system of FIG. 1, which will be described in detail below.

First, in step S10, the vehicle is currently traveling.

In step S20, when the vehicle is traveling in a driver driving mode described below, the controller CU may record a corresponding fuel efficiency and calculate and store an average fuel efficiency. The fuel efficiency in the driver driving mode may be continuously recorded and updated each time the driver driving mode is executed.

In step S30, when the vehicle is traveling in an autonomous driving mode, the controller CU may record and store a corresponding fuel efficiency. The fuel efficiency in the autonomous driving mode may also be recorded and updated each time the autonomous driving mode is executed.

In step S40, while the vehicle is traveling, the controller CU may compare a predicted driving distance to a destination and an available driving distance that is based on a power state of the power supply system.

For example, the available driving distance may be determined through a predetermined calculation according to a state of charge (SOC) of the high-voltage battery HV. For example, the available driving distance may be calculated by multiplying a fuel efficiency and an available energy of the high-voltage battery HV.

When calculating the available driving distance, information about weather, traffic congestion, and the like, which is received from an external server through vehicle-to-everything (V2X) communication, may also be considered. To this end, the controller CU may be communicatively connected to the external server through a communication device in the vehicle and receive necessary information.

In step S50, the controller CU may display the available driving distance on the display device based on a fuel efficiency in each mode such as the driver driving mode, the autonomous driving mode, and a super fuel-efficient driving mode.

The driver driving mode may be a manual driving mode, which is a non-autonomous driving mode, and may refer to a driving mode in which the driver has control.

As will be described below, the super fuel-efficient driving mode may be a mode in which power supply to the general electronic devices is cut off with only power supply to the essential electronic devices maintained.

The driver may select one from among the three modes described above according to the available driving distance for each mode displayed in step S50 and the predicted driving distance. To this end, a pop-up window for the selection may be displayed on the display device in the vehicle.

In step S60, according to the selection by the driver, one of the driver driving mode, the autonomous driving mode, and the super fuel-efficient driving mode may be determined. In this case, the driver may select a mode having the available driving distance that may satisfy the predicted driving distance.

Step S70 may represent a case where the driver driving mode is selected, and the vehicle may travel in the driver driving mode accordingly.

Step S80 may represent a case where the autonomous driving mode is selected, and the vehicle may travel in the autonomous driving mode accordingly.

Step S90 may represent a case where the super fuel-efficient driving mode is selected, and the controller CU may perform steps S100 and S110 accordingly.

In step S100, the controller CU may control the first switch SW1 and the second switch SW2 to block the power supply to the general electronic devices, excluding the power supply to the essential electronic devices.

That is, the first switch SW1 and the second switch SW2 may be switched off to block the power supply to the general electronic devices including the first to fifth general electronic devices GL1 to GL5.

In step S100, the controller CU may restrict sudden acceleration and sudden start of the vehicle through control by a drive motor controller CU and may also control the emergency lights to blink.

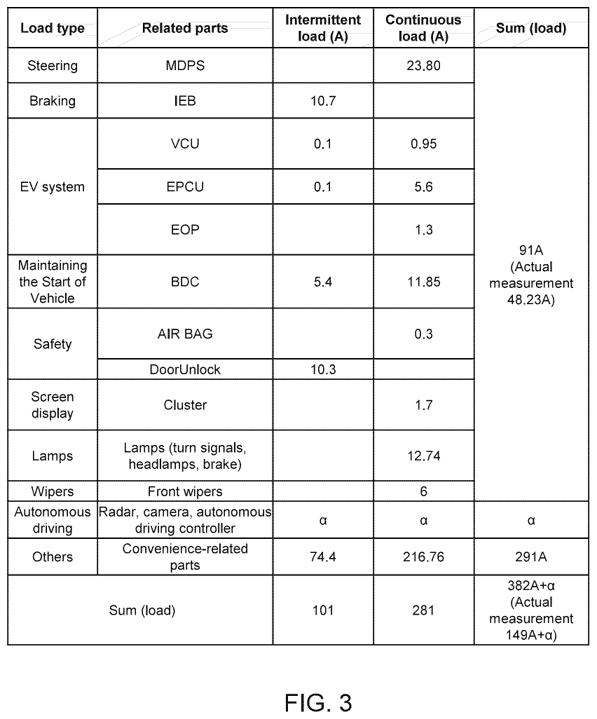

FIG. 3 illustrates example types of loads in a vehicle.

Referring to FIG. 3, a continuous load of 23.8A may be applied to the MDPS system related to steering; an intermittent load of 10.7A may be applied to the IEB related to braking; an intermittent load of 0.1A and a continuous load of 0.95A may be applied to the VCU related to an electric vehicle system; an intermittent load of 0.1A and a continuous load of 5.6A may be applied to the EPCU; a continuous load of 1.3A may be applied to the EOP; an intermittent load of 5.4A and a continuous load of 11.85A may be applied to the BDC to keep the vehicle started; a continuous load of 0.3A may be applied to the airbags for safety; an intermittent load of 10.3A may be applied to the door unlock system; a continuous load of 1.7A may be applied to the instrument cluster for screen display; a continuous load of 12.74A may be applied to the lamps; and a continuous load of 6A may be applied to the wipers. These loads may be essential loads that are designed to be applied as described above, but an actual total load was measured as 48.23A in contrast to a designed value of 91A.

Meanwhile, referring to FIG. 3, a convenience load, other than the essential loads, may be a total of 291A as its designed value.

In addition, a total sum of the essential loads and the convenience load is 382A as a designed value, but its actual measurement result was 149A.

The vehicle provided as an example in FIG. 3 has a battery capacity of 77.4 kW, an average fuel efficiency of 6.46 km/kWh, and an average driving distance of 500 km.

For the vehicle in FIG. 3, the total sum of the essential loads is 48.23A as the actual measurement value, which corresponds to about 32% of the actual total load measurement value of 149A. Therefore, when the vehicle travels in super fuel-efficient driving mode, i.e., when power is supplied only to the essential loads, an available driving distance may increase from 500 km to 1563 km.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

What is claimed is:

1. A vehicle, comprising:
at least one essential electronic device belonging to a first load class;
at least one general electronic device belonging to a second load class;
a power supply system configured to supply power to the at least one essential electronic device and the at least one general electronic device;
a switch configured to switch an electrical connection between the power supply system and the at least one general electronic device; and
a controller configured to control the switch,
wherein the controller is configured to control the switch to turn on or off a power supply to the at least one general electronic device based on a power state of the power supply system and a predicted driving distance to a destination.

2. The vehicle of claim 1, wherein the first load class includes essential loads for devices necessary to drive the vehicle, and the second load class includes convenience loads for devices optionally operated for user convenience.

3. The vehicle of claim 2, wherein the essential loads comprise a load related to at least one of a motor driven power steering (MDPS) system, an integrated electric brake (IEB), a vehicle control unit (VCU), an electric power control unit (EPCU), an electric oil pump (EOP), an advanced driver assistance system (ADAS), headlamps, turn signals, a brake light, wipers, an instrument panel (cluster), a door unlock system, and a body domain controller (BDC).

4. The vehicle of claim 1, wherein the power state comprises an available driving distance of a battery of the vehicle.

5. The vehicle of claim 4, wherein the controller is configured to:
in response to the available driving distance being less than the predicted driving distance, display an available driving distance for each of at least one driving mode through a screen in the vehicle.

6. The vehicle of claim 5, wherein the at least one driving mode comprises at least one of a driver driving mode, an autonomous driving mode, and a super fuel-efficient driving mode.

7. The vehicle of claim 6, wherein the controller is configured to, based on a selection by a driver of the vehicle or a comparison of the available driving distance for each driving mode, determine one from among the driver driving mode, the autonomous driving mode, and the super fuel-efficient driving mode.

8. The vehicle of claim 7, wherein in the super fuel-efficient driving mode, the power supply to the at least one general electronic device is turned off.

9. The vehicle of claim 8, wherein in the super fuel-efficient driving mode, sudden acceleration and/or sudden start are restricted, and emergency lights blink.

10. The vehicle of claim 5, wherein the controller is configured to store at least one of a fuel efficiency in the driver driving mode or a fuel efficiency in the autonomous driving mode.

11. A method of controlling a vehicle, the method comprising:
providing at least one essential electronic device belonging to a first load class, at least one general electronic device belonging to a second load class, a power supply system configured to supply power to the at least one essential electronic device and the at least one general electronic device, a switch configured to switch an electrical connection between the power supply system and the at least one general electronic device, and a controller configured to control the switch;
controlling, by the controller, the switch to turn on or off a power supply to the at least one general electronic device based on a power state of the power supply system and a predicted driving distance to a destination.

12. The method of claim 11, wherein the first load class includes essential loads for devices necessary to drive the vehicle, and the second load class includes convenience loads for devices optionally operated for user convenience.

13. The method of claim 12, wherein the essential loads comprise a load related to at least one of a motor driven power steering (MDPS) system, an integrated electric brake (IEB), a vehicle control unit (VCU), an electric power control unit (EPCU), an electric oil pump (EOP), an advanced driver assistance system (ADAS), headlamps, turn signals, a brake light, wipers, an instrument panel (cluster), a door unlock system, and a body domain controller (BDC).

14. The method of claim 11, wherein the power state comprises an available driving distance of a battery of the vehicle.

15. The method of claim 14, comprising:
in response to the available driving distance being less than the predicted driving distance, displaying, by the controller, an available driving distance for each of at least one driving mode through a screen in the vehicle.

16. The method of claim 15, wherein the at least one driving mode comprises at least one of a driver driving mode, an autonomous driving mode, and a super fuel-efficient driving mode.

17. The method of claim 16, comprising:
by the controller, determining one from among the driver driving mode, the autonomous driving mode, and the super fuel-efficient driving mode, based on a selection by a driver of the vehicle or a comparison of the available driving distance for each driving mode.

18. The method of claim 17, wherein, in the super fuel-efficient driving mode, the power supply to the at least one general electronic device is turned off.

19. The method of claim 18, wherein, in the super fuel-efficient driving mode, sudden acceleration and/or sudden start are restricted, and emergency lights blink.

20. The method of claim 15, comprising:
by the controller, storing at least one of a fuel efficiency in the driver driving mode or a fuel efficiency in the autonomous driving mode.
